(19) United States
(12) Patent Application Publication
(10) Pub. No.: US 2012/0031815 A1
(43) Pub. Date: Feb. 9, 2012

(54) PILL SORTING STYLUS TOOL AND PILL SORTING SYSTEM

(75) Inventor: Leonard Jay WALTER, Flossmoor, IL (US)

(73) Assignee: Len Walter Enterprises, LLC, Flossmoor, IL (US)

(21) Appl. No.: 12/851,324

(22) Filed: Aug. 5, 2010

(51) Int. Cl. B07B 13/00; B65D 83/04; B65H 3/32

(52) U.S. Cl. 209/45; 221/210

(57) ABSTRACT

A pill sorting system to sort, channel, and discharge a plurality of pills. The system includes a sorting tray having a sorting region to receive the plurality of pills and a discharge region including a spout configured to discharge pills from the tray. The system also includes a stylus tool having a body with a first and second end. The first end includes adhesive to pick up a pill and the second end is adapted to sort and move pills within the tray and through the spout.

### FIELD

The subject matter of the application relates to a stylus tool and pill sorting system to sort, channel, place, and discharge a plurality of pills.

### BACKGROUND

Non-prescription and prescription pharmaceuticals, such as vitamins and medicines, can be essential to the maintenance of an individual's health. Depending on the health and age of the individual, an individual may need to take several pharmaceuticals a day at different times throughout the day. Pharmaceuticals are often in the form of pills, tablets, capsules, caplets, or other forms. While the term pill may be used herein, other forms are also contemplated. Pharmaceuticals may be stored in bottles, organizers and other receptacles. Pharmaceuticals may be placed in such receptacles by pharmacists, patients, or other individuals. Sometimes, caretakers assist individuals in managing and organizing pharmaceuticals. Some pills may be toxic for caretakers to handle physically. There exists a need for a tool to assist in the pick-up, sorting and placement of pharmaceuticals for the consuming individual.

Existing tools to assist in the management of pills may be cumbersome and difficult to use. There exists a need to have an easy-to-use tool and system to help the pick-up and placement of pills into containers, such as pill organizers.

### SUMMARY

According to one aspect of the invention, there is provided a stylus tool to sort and pick up pills, the stylus tool comprising: a body including a first end having adhesive to pick up a pill; and a second end distal to the first end, wherein the second end is adapted to sort and move pills.

According to another embodiment of the invention, a pill sorting system to sort, channel, and discharge a plurality of pills is provided, the system comprising: a sorting tray having a sorting region to receive the plurality of pills, and a discharge region including a spout configured to discharge pills from the tray; and a stylus tool comprising a body including a first end having adhesive to pick up a pill, and a second end distal to the first end, wherein the second end is adapted to sort and move pills within the tray and through the spout.

According to a further aspect of the invention, there is provided a method of sorting pills with a stylus tool and sorting tray, comprising: receiving a plurality of pills in a sorting region of the sorting tray; attaching one of the plurality of pills to the stylus tool; moving the one pill with the stylus tool from the sorting region to a discharge region of the sorting tray; and discharging the one pill from the discharge region.

### BRIEF DESCRIPTION OF THE DRAWINGS

The subject matter of the application will be more readily understood from the following detailed description when read in conjunction with the accompanying drawings, in which:

FIG. 1 is a top perspective view of a stylus tool with a sorting tray according to an embodiment of the invention;

FIG. 2 is a bottom perspective view of the stylus tool and sorting tray of FIG. 1;

FIG. 3 is a top perspective view of the stylus tool attaching a pill in the sorting tray according to another embodiment of the invention;

FIG. 4 is a left side view of the stylus tool and sorting tray of FIG. 1;

FIG. 5 is a back side view of the stylus tool and sorting tray of FIG. 1;

FIG. 6 is a perspective view of a stylus tool with a pick-up component according to an embodiment of the invention;

FIG. 7 is a perspective view of the stylus tool of FIG. 6 without the pick-up component;

FIG. 8 is a bottom perspective view of the stylus tool with the pick-up component;

FIG. 9 is a side view of a pick-up component connection according to an embodiment of the invention;

FIG. 10 is an exploded view of the connection between the stylus tool and the pick-up component of FIG. 8;

FIG. 11 depicts a series of pick-up components; and

FIG. 12 is a side exploded view of FIG. 9.

### DETAILED DESCRIPTION

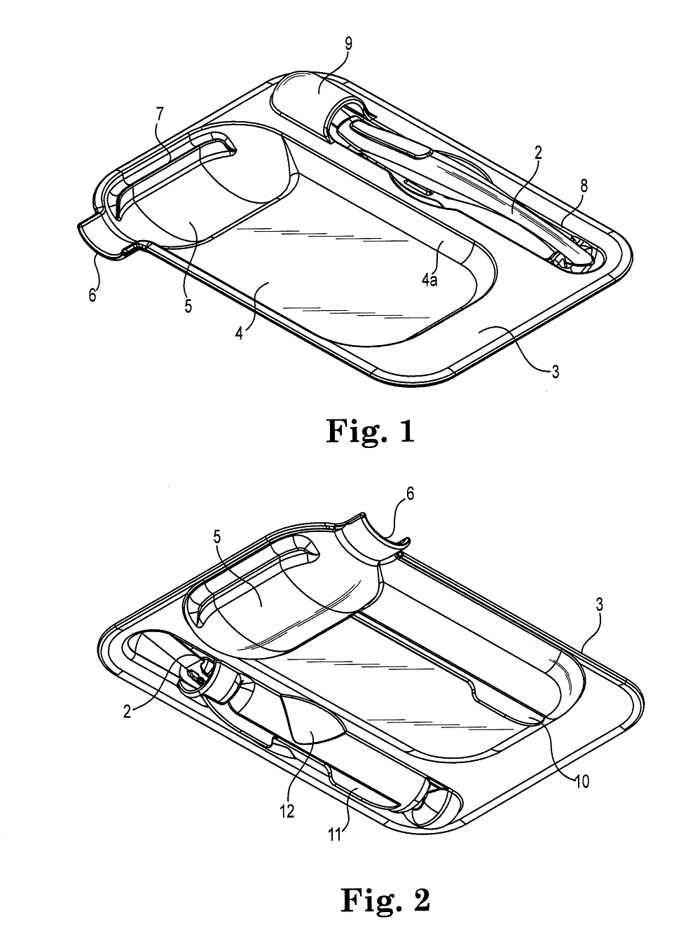

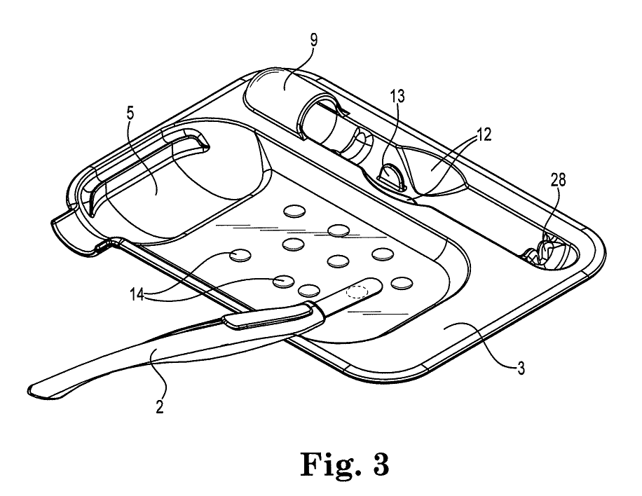

FIG. 1 shows an embodiment of the invention depicting pill sorting system 1 having a stylus tool 2 and a sorting tray 3. The stylus tool 2 cooperates with pills 14 to move and transfer the pills as shown in FIG. 3. The tool and system could be used with capsules, caplets, tables or other forms. Additionally, the tool and system could be used to sort other items, such as screws or other hardware. The sorting tray 3 may be made of injection-molded plastic or other suitable material.

The embodiment of the sorting tray 3 shown in FIG. 1 includes a sorting region 4 to receive a plurality of pills and a discharge region 5 configured to discharge pills from the sorting tray 3. The sorting region typically has a rim to help retain the pills. In the embodiment shown in FIG. 1, the sorting region is formed by a depression and the rim by the walls of the depression. Alternatively, a wall could also extend up from the surface of the tray. Some embodiments may not include a discharge region. According to such an embodiment, the pills could be discharged directly from the sorting region.

The discharge region 5 may include a discharge ridge 7 configured to cooperate with the stylus tool 2 to detach a pill adhered to the stylus tool 2. Along these lines, the stylus tool could be dragged along the ridge 7 so that the pill is removed from the stylus tool. The ridge can help to retain pills in the discharge region as tray is tipped to discharge the pills. If the tray does not include a ridge, the tool could be dragged on the edge of the discharge region or sorting region. The stylus tool could also be used to transfer pills directly to a bottle, organizer, compartmented pill box or other container.

The sorting tray 3 may include a stylus tool receiving portion 8 to house and retain the stylus tool 2 when the stylus tool 2 is not in use, such as during storage or transport. The stylus tool receiving portion 8 may include a cover 9 portion to protect at least a portion of the stylus tool 2. The sorting tray may also include elements to help immobilize and/or retain the stylus tool in the sorting tray.

FIG. 2 shows a bottom perspective view of the stylus tool 2 and sorting tray 3 of FIG. 1. The sorting region 4 and the discharge region 5 may have different depths. This can help to sort and segregate pills during sorting and/or discharge. The underside of sorting region 4 may include one or more risers, such as riser 10, to stabilize the sorting tray 3 in accordance with the depth of the discharge region 5 when the tray is supported on a surface. The underside of the stylus tool receiving portion 8 may also include a riser 11 to further stabilize and balance the sorting tray 3.

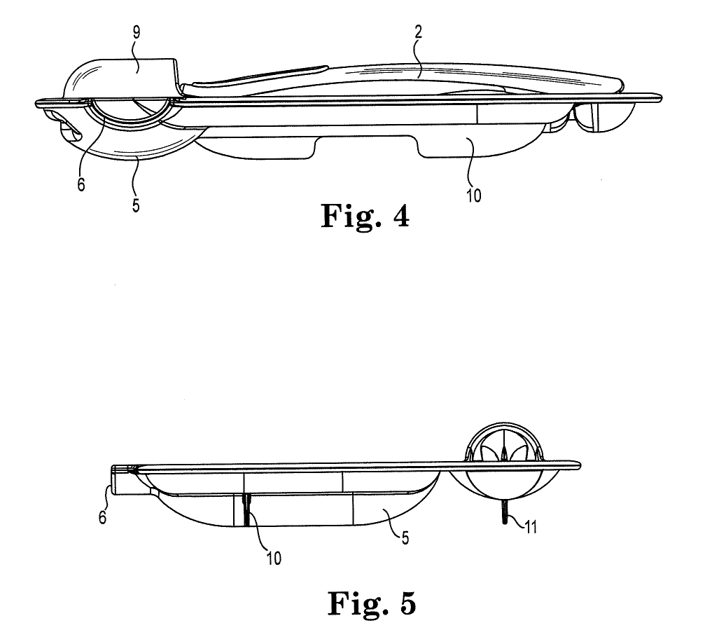

FIGS. 4 and 5 depict a left side view and a back side view of the stylus tool and sorting tray of FIG. 1, respectively. In this embodiment, the discharge region 5, the riser 10, and the riser 11 are positioned so that the sorting tray 3 may lie substantially level if supported on a surface. The different depths of the sorting region 4 and the discharge region 5 according to this embodiment are clearly depicted in these FIGS. 4 and 5.

As depicted in the embodiment of FIGS. 1 and 2, the discharge region 5 may have a concave shape creating a basin. The discharge region 5 may transition into the spout 6. The spout 6 may also have a concave shape to easily discharge the pills from the discharge region 5. The discharge ridge 7 may run longitudinally along the discharge region 5. In one embodiment, the underside of the discharge ridge 7 may additionally assist in stabilizing the sorting tray 3. In another embodiment, the discharge region 5 may be detachable from the sorting tray 3 to easily pour the pills through the spout 6. The sorting region may include a discharge sport to discharge pills. Such an embodiment may not include a separate discharge region.

FIG. 3 provides a top perspective view of the embodiment of the invention shown in FIGS. 1 and 2, but with the stylus tool in use. Along these lines, the stylus tool 2 is positioned outside the stylus tool receiving portion 8. This view illustrates how the side walls of the stylus tool receiving portion 8 may include contoured regions 12 to help grip the stylus tool with fingers. Also, the embodiment shown in FIG. 3 includes a link 13 configured to help secure the stylus tool 2 to the sorting tray 3. The link may engage a slot in the stylus tool. In an alternate embodiment, the stylus tool receiving portion 8 may be separate from the sorting tray 3.

The stylus tool-receiving portion 8 may also include a rest assembly 28. The rest assembly 28 may receive an end of the stylus tool. The rest assembly may also grip the stylus tool to help secure the stylus in place on the sorting tray 3. Along these lines, the rest assembly may include a pair of extensions that grip the end of the stylus tool as shown in FIG. 3.

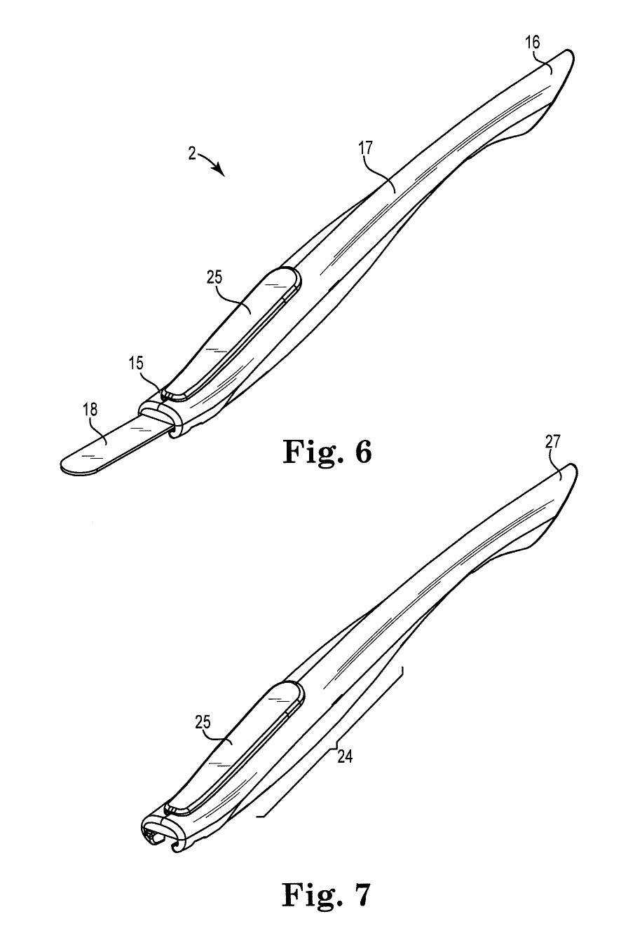

FIGS. 6-8 depict perspective views of the stylus tool according to an embodiment of the invention. This embodiment of the stylus tool 2 has a body 17 with a first end 15 and a second end 16. The stylus tool 2 includes a pill pick-up component 18 located at or in the vicinity of the first end 15. The pick-up component typically is detachable from the stylus tool. However, the pick-up component may be a permanent part of the stylus tool. The pick-up component could be attached mechanically, with adhesive or otherwise to the stylus tool. In an embodiment, the pick-up component may include, but is not limited to, styrene, other plastic materials, wood, or metal. Other suitable materials may be used for the pick-up component 18. According to some embodiments, the pick-up component is integral with the stylus tool. According to one such embodiment, the pick-up component includes one or more adhesive regions on the stylus tool, such as in the vicinity of an end of the stylus tool. The adhesive region could be replaceable or renewable. The stylus tool could also be disposable rather than renewing or replacing the adhesive.

The embodiment shown in FIGS. 6-8 includes a detachable pick-up component. At least one region of the detachable pick-up component 18 has adhesive characteristics in order to pick up a pill, as depicted in FIG. 3. The adhesive could be arranged on one or both sides of pick-up component. Typically, the adhesive has a strength sufficient to pick up a pill, tablet or other form, but weak enough not to physically damage or remove any of the pill upon removal of the pill from the adhesive.

The pick-up component 18 may be disposable or may be a permanent part of the stylus tool with renewable adhesive capabilities. The pick-up component 18 may have some flexibility to prevent the pills 14 from being crushed. The sorting tray or even the stylus tool itself could include Extra pick-up components 18 may be stored in a compartment of the sorting tray 3 or in the body of the stylus tool 17.

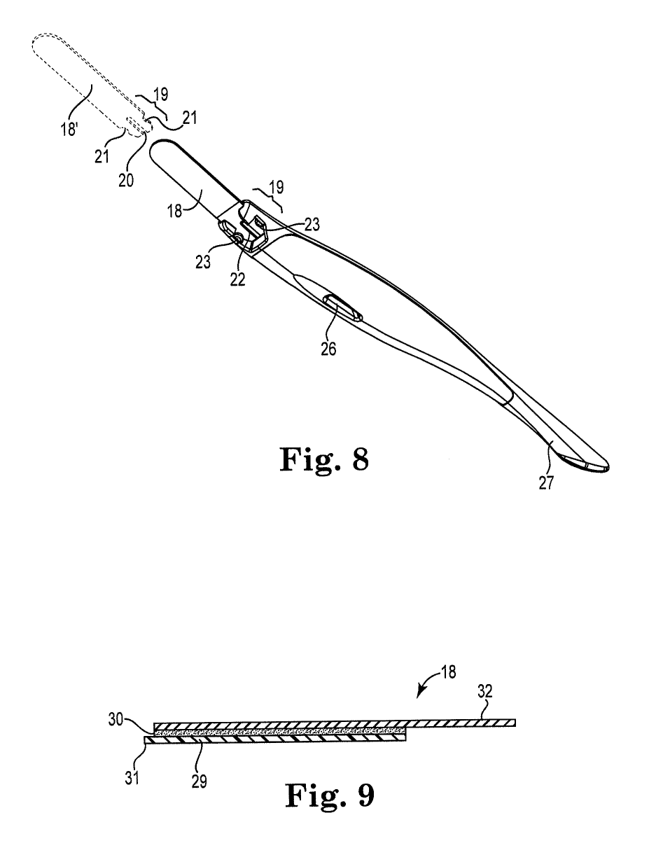

The pick-up component and/or the stylus tool may include one or more elements of an attachment mechanism. FIG. 8 illustrates en embodiment of an attachment mechanism 19 that is configured to attach the pick-up component 18 to the first end 15.

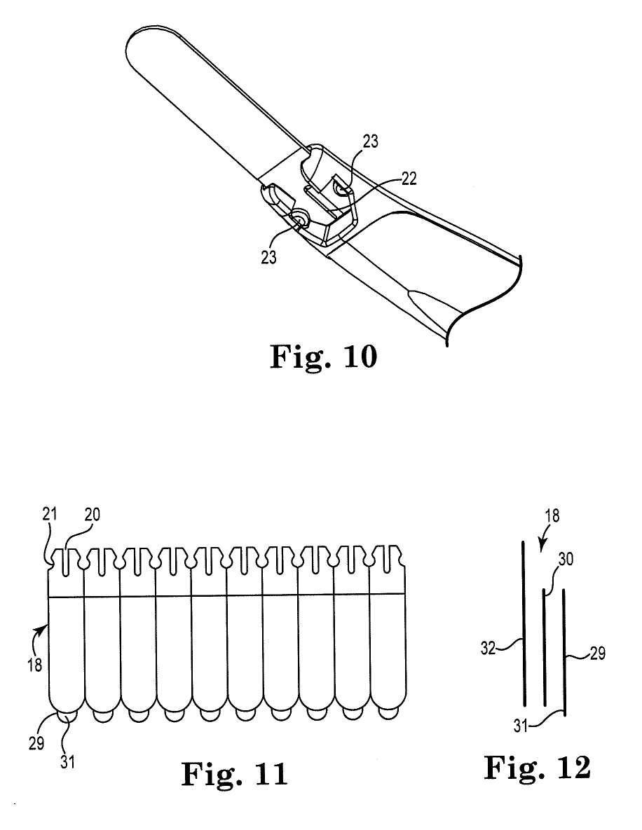

FIG. 10 provides an exploded view of the attachment mechanism 19 in FIG. 8. This embodiment of the attachment mechanism 19 includes interengaging elements on both the pick-up component 18 and the stylus tool 2. The interengaging elements are configured to retain the pick-up component 18 on the stylus tool 2. As shown in FIG. 10, the interengaging elements may include a slot-tab assembly. The pick-up component 18 may include a slot 20 and indents 21. The stylus tool 2 may have a tab 22 and projections 23 to couple with the slot 20 and indents 21, respectively. FIG. 8 illustrates the pick-up component 18′ before attachment to the stylus in broken lines, and also attached to the stylus and secured in place by the attachment mechanism 19. FIG. 10 again shows the pick-up component 18 attached to the stylus tool. Once the pick-up portion is attached to the stylus tool, the tab 22 will be located in the slot 20 and projections 23 will be arranged in the indents 21. The attachment mechanism could also include only one of the slot and tab or projection and indents.

In an alternate embodiment of the attachment mechanism, the first end 15 of the stylus tool may include a removable cap defining a narrow slot. The pick-up component 18 may fit through the narrow slot except for a wider end portion of the pick-up component 18. The removable cap may attach to the first end 15 with the pick-up component 18 positioned through the narrow slot. Since the wider end portion of the pick-up component 18 is prevented from exiting the narrow slot, the pick-up component 18 may remain secure positioned through the slot but fixed to the first end 15. An embodiment that includes a cap may not need a slot and indents on the pick-up portion or stylus. Additionally, the cap and/or the stylus may include mechanical elements configured to retain the cap on the stylus.

In a further embodiment of the attachment mechanism, the pick-up component 18 may include a passage extending at least partially through the thickness of the pick-up portion. The first end 15 of the stylus tool 2 may include a tab insertable into the passage. The stylus may include a spring-loaded locking feature to lock the tab into the hole. Other locking features may also be used.

The pick-up component 18 may have adhesive arranged on the top surface to assist in attaching the pick-up component 18 to the body 17 in addition to, or in place of the attachment mechanism.

The top and/or bottom surface of the pick-up component 18 may have adhesive characteristics to pick up a pill 14. One of the adhesive surfaces may be pressed onto a pill 14 to attach the pill 14 to the pick-up component 18. The adhesive surface(s) may have a detachable film cover or liner 29 to protect the adhesive capabilities prior to using the pick-up component 18 to secure pills 14. The adhesive may be pre-applied to the pick-up component 18 or the pick-up component 18 may be dipped into an adhesive or other substance to activate an adhesive property immediately prior to use.

As depicted in FIG. 8, the body 17 of the stylus may include a contoured grip section 24 located between the first end 15 and the second end 16. The contoured grip section 24 may rest ergonomically in a hand or may be gripped by a hand. The body 17 may additionally have a finger or thumb rest assembly 25. The finger or thumb rest assembly 25 may be a raised narrow tab strip arranged on the body 17. In an alternate embodiment, the finger or thumb rest assembly 25 may comprise soft grip bumps. In a further embodiment, the finger rest assembly 25 may include one or more concave or convex portions of the body 17 or one or more attachments having a convex or concave outer surface attached to the body 17. In the contoured grip section 24, the body 17 may be thicker away from the first end 15 in a longitudinal direction and thinner proximate the second end 16. The material of the contoured grip section 24 may be different from the body 17.

The stylus tool 2 may also have a link-engaging element 26, such as a recess. The link-engaging element 26 may cooperate with the link 13 of the sorting tray 2 to link or engage the stylus tool 2 to the stylus receiving portion 8 described above.

The second end 16 of the stylus tool 2 may have a spatula 27 that can assist with sorting and moving pills 14. The spatula 27 may have a reduced thickness as compared to most of the other portions of the body 17 of the stylus tool 2. The stylus tool receiving portion 8 of the tray may include a spatula rest assembly 28 to receive the spatula 27 and secure the second end 17 in place on the sorting tray 3.

FIG. 9 is an exploded side view of the pick-up component 18 according to an embodiment of the invention. The pick-up component may include a base 32 that can include the slot and indents to attached the pick-up component to the body 17. One surface of the base 32 may include an adhesive material 30 attached. An example of adhesive material 30 may include, but is not limited to, non-toxic glue, binder, and sealant. For example, 3M™ adhesive #9874 or #1522 and ‘Hollywood Fashion Tape’ may be used as adhesive materials. Other adhesives with higher or lower adhesive strength could be utilized as long as the adhesive can pick up a pill and not physically remove any of the pill upon discharge. Other adhesives that might be utilized could include 3M™ adhesive #1509, 1513, 1567 and 1504XL. The adhesive material 30 may be covered by a detachable film cover 29 that protects the adhesive material 30 prior to use. The film cover 29 may extend past the pick-up component 18 to create a lip 31 to easily detach the film cover 29 from the pick-up component 18 in order to expose the adhesive material 30.

The pick-up component could be formed individually or in groups. FIG. 11 depicts a top view of an embodiment of the pick-up component 18, where the pick-up component 18 may be formed in a series of pick-up components. A respective pick-up component 18 may be detachable from the series by, for example, perforated edges between adjacent pick-up components. FIG. 11 clearly shows the lip 31 of the film cover 29 extending past the pick-up component 18 to facilitate removal of the cover. In one embodiment, the lip 31 may have a smaller radius of curvature than the end of the pick-up component 18. FIG. 12 shows a side view of the embodiment of the pick-up component 18 shown in FIG. 9. The film cover 29 may be included to protect the adhesive 30 that is adhered to the pick-up component 18 and prevent anything from sticking to the adhesive. The lip 31 may extend past the pick-up component 18 and the adhesive 30.

As depicted in FIG. 3, the stylus tool 2 may attach the pill 14 with the adhesive 30 on the pick-up component 18. Once the pick-up component 18 is pressed onto the pill 14, and the pill attached to the adhesive, the pill 14 may be carried to the discharging region 5 with the stylus tool 2. The pill could also be carried directly to a dispensing bottle, compartmented pill box or other receptacle. Using the discharge ridge 7, a lip of a container or other structure, the adhered pill 14 may be detached from the pick-up component 18 and fall into the basin of the discharge region 5, into a bottle, compartmented pill box or other receptacle. The sorting tray 3 may then be tipped to pour the discharged pill 14 out of the sorting tray 3. The spatula 27 of the second end 16 of the pick-up component may alternately push the pill through the spout 6 to move the pill from the discharge region 5.

It will be understood that the above description of the present invention is susceptible to various modifications, changes and adaptations, and the same are intended to be comprehended within the meaning and range of equivalents of the appended claims.

1. A stylus tool to sort and pick up pills, the stylus tool comprising
a body including a first end and a second end distal to the first end, wherein the second end is adapted to sort and move pills;
a replaceable pick-up component comprising a base and adhesive arranged on the base; and
interengaging attachment elements on the body and the replaceable pick-up component configured to removably attach the base of the replaceable pick-up component to the first end of the body.

2. (canceled)

3. The stylus tool according to claim 1, wherein the pick-up component is disposable.

4. The stylus tool according to claim 1, wherein the adhesive is arranged on a first side of the base.

5. (canceled)

6. The stylus tool according to claim 1, wherein the interengaging elements comprise at least one slot on the pick-up component and a tab and projections on the body of the stylus tool.

7. The stylus tool according to claim 1, wherein the body further comprises a contoured grip section between the first end and the second end, the grip section being adapted to be gripped by a hand.

8. A pill sorting system to sort, channel, and discharge a plurality of pills, the system comprising:
a sorting tray having a sorting region to receive the plurality of pills, and a discharge region including a spout configured to discharge pills from the tray; and
a stylus tool comprising a body including a first end having adhesive to pick up a pill, and a second end distal to the first end, wherein the second end is adapted to sort and move pills within the tray and through the spout.

9. The pill sorting system according to claim 8, wherein the sorting tray further comprises a stylus tool receiving portion.

10. The pill sorting system according to claim 8, wherein the stylus tool receiving portion includes a link configured to secure the stylus tool to the tray.

11. The pill sorting system according to claim 10, wherein the stylus tool further comprises a link-engaging element.

12. The pill sorting system according to claim 11, wherein the link-engaging element comprises a recess.

13. The pill sorting system according to claim 8, wherein the body of the stylus tool comprises a contoured grip section between the first end and the second end, the grip section being adapted to be gripped by a hand.

14. The pill sorting system according to claim 8, wherein the sorting region and the discharge region have different depths.

15. The pill sorting system according to claim 8, wherein further comprising:
a pick-up component on which the adhesive is arranged; and
an attachment mechanism configured to attach the pick-up component to the first end of the stylus tool.

16. The pill sorting system according to claim 8, wherein the pick-up component comprises a top surface on which the adhesive is arranged.

17. The pill sorting system according to claim 8, wherein the pick-up component and the stylus tool comprise interengaging elements configured to retain the pick-up component on the stylus tool.

18. The pill sorting system according to claim 19, wherein the interengaging elements comprise at least one slot on the pick-up component and a tab and detents on the body of the stylus tool.

19. A method of sorting pills with a stylus tool and sorting tray, comprising:
receiving a plurality of pills in a sorting region of the sorting tray;
attaching one of the plurality of pills to the stylus tool;
moving the one pill with the stylus tool from the sorting region to a discharge region of the sorting tray; and
discharging the one pill from the discharge region.
